(19) United States
(12) Patent Application Publication
(10) Pub. No.: US 2006/0031509 A1
(43) Pub. Date: Feb. 9, 2006

(54) Resource management method

(76) Inventors: Marco Ballette, Colchester (GB); Antonio Liotta, London (GB)

Correspondence Address: STITES & HARBISON PLLC, 1199 NORTH FAIRFAX STREET, SUITE 900, ALEXANDRIA, VA, 22314, US

(21) Appl. No.: 11/197,526

(22) Filed: Aug. 5, 2005

(30) Foreign Application Priority Data
Aug. 6, 2004 (GB) 0417583.2

(51) Int. Cl. G06F 15/173

(52) U.S. Cl. 709/226

(57) ABSTRACT

A method for enabling the sharing of resources for the processing of tasks in a virtual organisation. The method includes the steps of storing resource information in a memory, monitoring the stored information and processing at least part of the stored resource information to calculate a resource matrix to determine how a task submitted to the virtual organisation will be processed.

This invention relates to a resource management method for enabling the sharing of resources in a virtual organisation.

Grid computing aims at enabling coordinated resource sharing and problem solving in dynamic, multi-institutional virtual organization. That is, the creation, from geographically distributed components operated by distinct organizations of a virtually integrated system that is sufficiently integrated to deliver the desired Quality of Service (QoS). Such virtual Organizations (VOs) can vary in their scope, degree of previous relationship, size, duration etc.

We outline a resource management method which enables mobile devices accessing the network via various technologies to form a VO of mobile devices to enable the sharing of all the resources available to the VO (processing power, battery, memory, storage, etc.).

While Grid computing is now a mature technology, which enables high computational resources to interact together in the execution of certain kind of parallelizable tasks, the integration of mobile devices resource into the grid resource-sharing paradigm is a relatively new development. The reason for this integration is due to the increasing ubiquity of mobile devices in the population. Given the increasing computational and memory capabilities of these mobile devices, the devices should be considered as a significant source of computational power (and other resources). Obviously, limitations of the mobile devices (in terms of unreliable connectivity status) and resource constraints (in terms of computational speed, bandwidth, memory etc.) must be taken into account to provide some sort of QoS in these dynamic environments which may be inherently unpredictable.

This resource management method addresses the aforementioned issues of resource constraints, unreliable connectivity, high dynamics etc. and provides mobile users with the opportunity to access Mobile Grids (Virtual Organizations of mobile devices) to share of resource among the users of the Mobile Grid. Mobile devices in a Mobile-grid environment will act both as resource consumers, when they want to exploit the collective resources of all the other devices participating in the community and as resource providers when they will provide resources for exploitation by other members of the group. Users of the grid will set up thresholds in order to indicate under which circumstances they want TO make their resources available to the mobile grid and based on that, each device joins a Mobile Grid will transparently interact with other devices in the mobile grid. A Mobile Grid middleware will be in charge of providing these capabilities transparently to the users and will address issues such as the frequent disconnections of these mobile devices and the virtualisation of the resources provided by each of the devices into the mobile grid.

Different roles are present in this management method. The resource management method is built on top of an existing framework which provides basic capabilities such as efficient service/resource discovery and support for executing distributed computing tasks such as transactional semantics, fault recovery etc.

By virtue of being built on top of such an existing framework, our resource management method is virtually independent of the various protocols used for discovering mobile devices and their resources within the Mobile Grid.

The concept of Grid computing started as a project to link supercomputing sites. The term Computational Grid is defined as “a hardware and software infrastructure that will provide dependable, consistent, pervasive and inexpensive access to high-end computational capabilities”. (I. Foster and C. Kesselaman (eds). The Grid Blueprint for a New computing Infrastructure 1999).

Nowadays the Grid concept is not only a computing paradigm aimed at providing resources for challenging applications, it has also emerged as a paradigm for coordinated resource sharing and problem solving in dynamic, multi-institutional virtual organization for industry and business. The Grid concept is defined as “coordinated resource sharing and problem solving in dynamic, multi-institutional virtual organization”.

A classic approach in building a computational Grids consist in the creation of an overlay middleware which provides an operating system-like abstraction of the underlying Grid resources (typically consisting of a large number of diverse and heterogeneous computers running different operating systems and based on different access policies) in order for the users not to be concerned with the complexities of the underlying system. The overlay middleware will also address issues of security, information, discovery, resource management, data management, communication and portability.

Current work in the field of grid middlewate is described in the Globus Project: A Status Report. I. Foster, C. Kesselman. Proc. IPPS/SPDP '98 Heterogeneous Computing Workshop, pp. 4-18, 1998; Globus GT3 Core—A Grid Service Container Framework. Global Grid Forum Draft Recommendation, Jun. 26, 2003; C Kesselman, S. Tuecke. The Anatomy of the Grid: Enabling Scalable Virtual Organizations. I. Foster, International J Supercomputer Applications, 15(3), 200. The globus project is currently considered as the de facto Standard Grid middleware. However, other projects are also in development, see for example

Grimshaw A., Wulf W. et al., The Legion Vision of a Worldwide Virtual Computer. Communications of ACM, vol. 40 (1), January 1997; A Takefusa, H Nakada, K Aida, H Ogawa, S Matsuoka and U Nagashima. Implementation and Preliminary Evaluation of Global cheduling Framework in Ninf IPS/SIG Notes, 98-HPC-72 (SWoPP'98), August 1998, and an Open Grid Service Architecture Implemented with Jini N Furtnento, W Lee, A Mayer, S Newhouse and J Darlington In SuperComputing 2002, Baltimore, UDSA, November 2002.

The integration of mobile devices into the Grid is a new field, which is gaining interest within the Grid community. The issue of integrating resource—constrained mobile terminals into the Grid raises problems due to the inherent limitations of typical mobile terminals; these issues are highlighted in T Phan, L Huang, C Dulan, “Integrating mobile devices into the computational grid”, Proc. of 8^{th} Intl conf on Mobile computing and networking, 2002, Arldana, Ga., USA. 4. An economic model is presented to motivate mobile users to connect with their handheld devices and, most importantly, a proxy-based clustered architecture is proposed to shield the constraints of mobile devices to the rest of the Grid. A proxy representing a number of devices and performing problem decomposition on their behalf achieves this:

“Communication Paradigms for Mobile Grid Users. CCGRID 2003”, investigates the converging field of Mobile and Grid computing by proposing a three-layered architecture for the provision of Grid services to mobile users. In the proposed three-layered architecture the first two layers provide basic Grid services (resource management, security, distributed access, distributed data management) and can be provided by existing Grid middleware (e.g. Globus. An agent-based platform is proposed at the top level formed by Grid mobile agents in charge of responding to the queries coming from agents representing the mobile users (User Agents).

An interdisciplinary “wireless grid” team comprised of Syracuse, Boston, and Tufts Universities as well as MIT and ETHZ, the Swiss Federal Institute of Technology—Zurich, and British Telecom and Cisco among others is conducting research on resource sharing protocols suitable for use in Virtual Organizations formed by a wireless network of resource constrained devices. Their work involves tackling of issues such as device management, efficient power saving routing protocols, mobile node discovery, node authentication as well as authorization across organization boundaries. This is described as Lee W McKnight, Mark Gaynor, Junseok Hwang, James Howison, Hawa Chang, Bor-rong Chen, Amar Gupta, and Bernhard Planruner. Wireless GRID Networks and Virtual Markets. Drafi submission GGF8. 2003.

The portal approach model, (as described in Miika Tuisku Wireless lava-enabled MIDP devices as peers in a Grid infrastructure) where mobile devices can be used solely to access more capable devices and services has also been extended using application protocols such as HHTP, and interfaces such as web portals.

“Beyond the “Device as Portal”: Meeting the Requirements of Wireless and Mobile Devices in the Legion Grid Computing System.” International Parallel and Distributed Processing Symposium: IPDPS 2002 Workshops Apr. 15-19, 2002 Fort Lauderdale, Fla., describes a feasibility study on enabling the most limited category of wireless J2ME devices to make use of Grid technologies, roles such as Computing elements (the capability of running small computational tasks or jobs on demand), Data producer: (Ability to register physical phenomena such as sensors or captors), Data consumer: (To provide intelligent user interface for remote analysis and control) and Storage elements: (To provide persistent storage for data produced) are recognised.

A mobile grid architecture composed of three different components has been proposed. (Sang-Min Park, Young-Bae Ko, and Jai, Hoon Kim. Disconnected Operation Service in Mobile Grid Computing. International Conference on Service Oriented Computing. (ICSOC'03), December 2003). The subsystems are static Grid sites, a group of mobile devices, and a gateway interconnecting static and mobile resources. Users of the Mobile Grid submit jobs through a mobile agent, which performs various tasks.

Various technologies are available for Shared Distributed Memory Spaces. One of the first such technologies was using Tuple spaces.

A Tuple space, (T Lehman, S McLaughry, P. Wyckoff, TSpaces; The Next Wave, Hawaii Intl. ConfE on System Sciences (HICSS-32), January 1999; D Gelemter. Generative communication in Linda, ACM Transactions on Programming Languages and Systems. 7 (1:80-112), January 1985), is a globally shared, associatively addressed memory space. The basic element is a ruple, which is an ordered collection of typed fields; the fields are either data objects or placeholders. Tuples are associatively addressed via matching with other tuples. In a message-sending system, a message must be explicitly directed to a receiver and only that receiver can read the message. By contrast, in tuple space coordination languages, any number of processes can read a message (the Tuple), and the sender does not need to know which process will read the message. On the server side, when the server generates a result that other processes need, it simply “dumps” it into the tuple space. This aspect promotes an uncoupled programming style.

The Tuple-space paradigm has its roots in early research conducted on artificial intelligence and blackboard communication architectures, where the term “blackboard communication” is used for a communication that is based on a publicly readable and writable data repository. These systems used the idea of a global state (the blackboard) on which experts from different backgrounds could collaborate to solve difficult problems. This architecture was widely recognized as an interesting and flexible solution to the problem of aggregating heterogeneous resources into a collaborative environment.

In the 1980's Tuple spaces gained popularity thanks to the Linda project at Yale University; (D Gelernter. Generative Communication in Linda. ACM Transactions on Programming Languages and Systems. 7(1:80-112), January 1985).

The result of the research on the Linda project was that by using an object store along with a small number of simple operations, a large class of parallel and distributed problems could be implemented using techniques that alleviate many of the pitfalls of building networked systems. In other words such space-based systems are not only simple (requiring only a few operations), but also expressive and lend themselves well to solving many distributed problems.

The Linda project inspired Sun's JavaSpace service; (E Freeman, S Hupfer, K Arnold. JavaSpaces Principles, Patterns and Practice. Addison-Wesley 1999). While JavaSpace inherited the space model from Linda, the designers of JavaSpace have updated the model in several significant ways, by providing the ability to ship around executable contents in objects, providing support for transactional semantics and providing support for notification of remote events. JavaSpace is a simple, expressive and powerful tool that eases the burden of creating distributed applications. Processes are loosely coupled and synchronize their activities using a persistent object store called a space, rather than through direct communication. This method of coordinating distributed processes leads to a flexible system.

As in Linda a space acts as a distributed shared memory where loosely coupled processes synchronize their activities by exchanging objects called Entries. Participants in a distributed application send and receive messages and tasks in the form of objects (entries) via the space. These entries are “leased”; persistency is subject to renewal in order to reduce garbage after failures. Each space takes care of all the details of communication, data transfer, persistence, synchronization, and security. The primitives used in JavaSpace are the following:
write: write an object implementing the common interface Entry into the space;
read, readIfExist: read the object matching a certain template (Entry) from the JavaSpace;
notify: Send a notification through a given event handler if entries that match a template are added to the space. A notification request has a time-out period associated with it: if a matching entry isn't added within the time-out period, the notify request fails and is dropped from the JavaSpace.
take, takeifExist: Read and remove an entry from the space.

The most useful properties provided by JavaSpace are:

Scalabiliry: the more workers in the space, the faster the tasks will be computed. Workers can be added and removed at run-time and the computation will continue as long as there is at least one worker to compute the tasks

Load balancing: workers running on slower CPU will compute their tasks slowly (and thus complete fewer tasks) than those running on faster CPU

Low coupling, master and workers are uncoupled. Workers do not have to know anything about the master and the specifics of the task, the workers simply compute the task and return the results to the space.

Sharing: Many remote processes can interact with a space concurrently—the space itself handles the details of concurrent access, leaving mobile-Grid application developers to focus on the design of the high-level protocols between processes.

Persistency: Spaces provide reliable storage for objects. Once stored in the space, an object will remain there until its lease time (which can be renewed) is over, or until a process explicitly removes it.

Spaces are persistent, associative, transactiorally secure and allow exchange of executable content. As JavaSpace provides high-level coordination mechanism through its primitives it eliminates worries about multithreaded server implementation, low level synchronization issues, network communication protocols etc.

JavaSpace is the most well known implementation of the shared distributed memory space paradigm and has been used in the testing of the resource management method of this application.

We consider the idea of distributed computing patterns. The execution of parallel and distributed programs follows typical patterns:

Master-Worker: where a client (Master) executes many, identical subtasks on a pool of servers,

Command: where a client (Master) executes different subtasks, each on a specific server,

Marketplace: where the execution task is governed by negotiation,

In enabling framework for master-worker applications on The computational grid Proceedings of the Ninth IEEE International Symposium on High Performance Distributed Computing, pages 43-50, 2000, a Java Space implementation of the Master Worker execution pattern is described. It has the following phases:

Task-planning: the master process first decomposes the application problem into subtasks.

The master then iterates through the application tasks, creates a task Entry for each task, and then writes each task entry into the JavaSpace. Typically the master will wait for a certain time (waiting time), if after this wailing time no results are published by the workers, the master will assume that a failure has occurred and the task is republished into the JavaSpace.

Computation: the worker process retrieves the tasks from the space, if a matching task is not immediately available, the worker process can wait until the task is published. The access to the task Entry is not regulated and no riles are made in order to regulate the access to tasks from the worker side.

Aggregation: the master collects the results previously published by the workers.

As previously mentioned this approach provides inherent support for scalability, load balancing and uncoupling in service, destination and time: A client (Master) does not have to be aware of a receiver's location and address, neither do the two (sender and receiver) have to exist at the same time. They can exchange messages through the space, and the space will store messages until they are read.

According to the invention, there is provided a resource management method for enabling the sharing of resources for the processing of tasks in a virtual organisation of terminals, said method comprising the steps of: storing information on resources provided by each of said terminals in a shared distributed memory means; monitoring and receiving said resource information from said shared distributed memory means in a monitoring means; receiving at least part of said resource information from said monitoring means in an adaptive reconfigurable resource broker means; receiving a task for processing from one of said terminals in an admission control means; processing said at least part of said resource information in said adaptive reconfigurable resource broker means to determine which said at least one terminal said task will be allocated to for processing.

This application is particularly concerned with the provision of a resource management method able to provide mobile and fixed terminals with efficient means for enabling the sharing of resources in a Mobile Grid.

The method inherits the Grid resource-sharing paradigm and applies it in a mobile context, where particular requirements arise due to the constrained and distributed nature of the mobile terminals. In this method, we consider a large number of limited resources provided by virtually unreliable mobile terminals forming what is referred to as Mobile Grid.

The method has a particular system architecture, and this architecture determines the policy adopted by an adaptive reconfigurable resource broker in order to choose the more suitable resource providers for each task submitted to the Mobile-Grid. This method is particularly suitable for heterogeneous mobile terminals since it takes into account the inherently volatile nature of the mobile terminals and the fact that resources published into the Mobile Grid can suddenly disappear, thereby dynamically varying the level of resource availability in the Mobile Grid system.

Moreover, users of the Mobile Grid are able to configure their mobile terminals in order to prevent the over-utilization of their terminal resources by the other terminals populating the Mobile Grid, by setting particular thresholds for each resource considered. Whenever the utilization of a particular resource crosses a specific user-defined threshold, the mobile terminal will automatically block the provision of that particular resource to the Mobile Grid

Embodiments of the invention will now be described, by way of example only, with reference to the accompanying figures, in which:

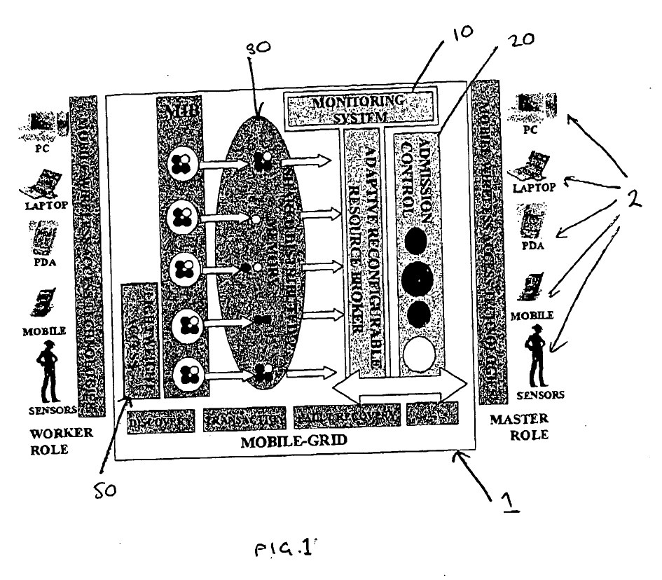

FIG. 1 shows mobile grid resource management architecture;

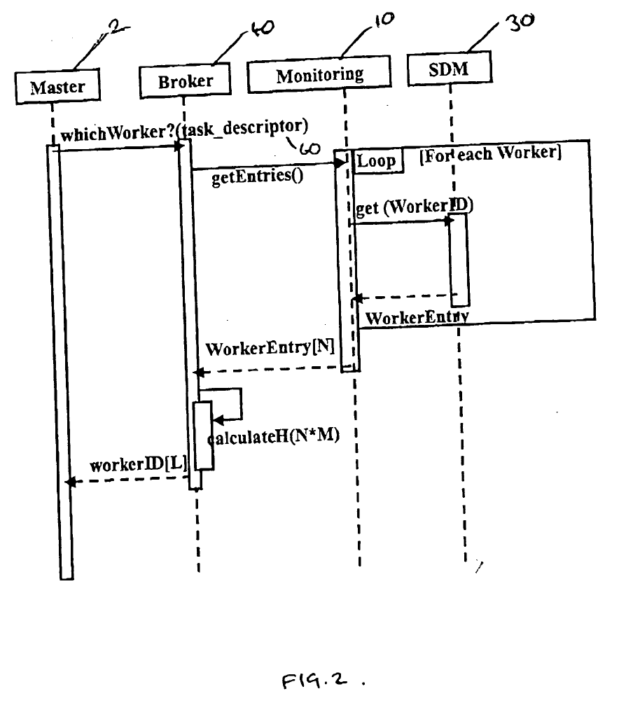

FIG. 2 shows a Master, Monitoring System and Adaptive Reconfigurable Resource Broker Service Interaction sequence diagram;

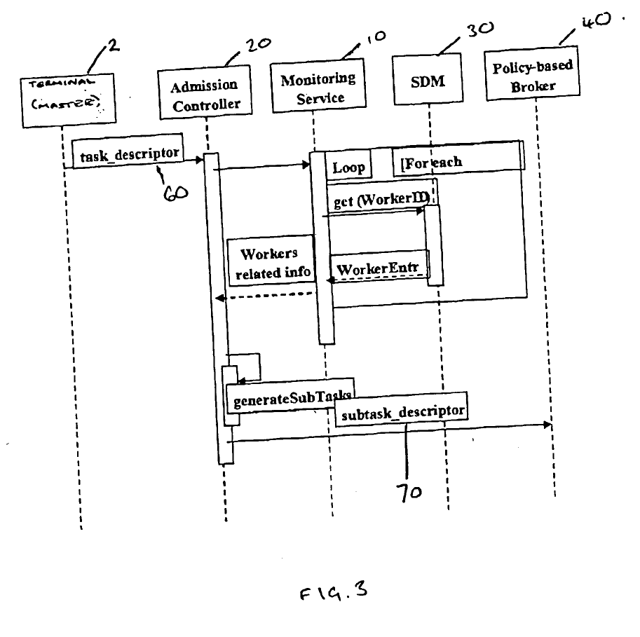

FIG. 3 shows a Master, Monitoring System, Admission Control module, and Adaptive Reconfigurable Resource Broker Service Interaction sequence diagram;

FIG. 1 illustrates a novel Adaptive and reconfigurable Resource Management Framework (5), which enables the sharing of services and resources within a virtual organization of mobile terminals (2). The virtual organisation is referred to as a Mobile Grid (5).

The framework (5) is comprised of terminals (2), which contribute to the mobile grid (1). The mobile grid includes monitoring system (10), an admission control module (20), a shared distributed memory (30), an adaptive reconfigurable resource broker (40) and a lightweight access module (50).

The terminals (2) access the Mobile-Grid (1) via a variety of Mobile Wireless Access Technologies including WLAN (wireless local area network), Bluetooth, IrDA (Infra-red data association), UMTS (Universal Mobile Telecommunications system), and the type of digital device operating as a terminal can vary over a wide range of resource provisions, constraints, capabilities and level of mobility, e.g. PCs with fixed network connection, laptops and PDA (Personal Digital Assistant) to more constrained devices such as mobile phones or sensors. These last two categories of devices may need a further layer, the Lightweight Access module (50) in order to access the Mobile Grid (1).

Terminals (2) may act both as Workers, who are willing to provide their resources to the other terminals (2) within the Mobile Grid (1) and as Masters, when they submit a computational or memory intensive task to the Mobile Grid (1) for processing by the resources available to the Mobile Grid (1).

Masters submit tasks for processing to the admission control module (20) and the Admission Control module (20) will then publish the task in the Shared Distributed Memory (30). The publication of the task is in the form of an object, referred to as a TaskEntry, along with the executable code and the Worker IDs (a unique device identifier) chosen by the resource management method and the executable code.

The Shared Distributed Memory (30), monitoring system (10) and adaptive reconfigurable resource broker (40) are services that can be provided by different terminals (2) within the Mobile-Grid. Alternatively one terminal (2) may be able to provide all of the three services to the Mobile Grid community. The terminals (2) providing these services can be found through some known service discovery mechanism that is used by the mobile grid.

This resource management method is built on top of a service discovery protocol and is independent of the technology used in the service discovery protocol. The resource management method requires the following attributes from the service discovery protocol;
the protocol for the service discovery has to provide plug&play functionalities: to dynamically add and delete services made available by the terminals (2) forming the Mobile Grid (1).

The service discovery protocol must be lightweight, in order to enable resource-constrained terminals (2) such as PDAs or mobile phones to participate.

Existing discovery protocols offering the aforementioned capabilities are: OSGi framework, (Johan Vos and Steven Buytaert and Dries Buytaert. A dynamic service delivery framework based on the OSGi model. In proceedings of SSGRR 2002); the Salutation Protocol; (www.salutation.org); the Service Location protocol (SLP) (C Bettstetter and C Renner. A comparison of service discovery protocols and implementation of the service location protocol, in Proceedings EUNICE); the Universal Plug & Play protocol (C Bertstetter and C Renner. A comparison of service discovery protocols and implementation of the service location protocol, in Proceedings EUNICE); the UCB Ninja protocol; (C Bettstetter and C Renner. A comparison of service discovery protocols and implementation of the service location protocols and implementation of the service location protocol, in Proceedings EUNICE); and the Jini protocol (Newmarch Jan. Jan Newmarch's Guide to JINI Technologies. Apress 2003).

If none of the terminals (2) contributing to the Shared Distributed Memory (30) can provide a Monitoring and Policy-based Brokering management function, the Mobile Grid Resource Management method can be easily bypassed and workers will follow the classic Master-Worker execution pattern provided by the semantics of the particular shared distributed memory space technology utilized. In this case, the resource providers will hungrily compete to get access to the TaskEnrries published by the Masters in the Shared Distributed Memory and execute the tasks following the classic Master-Worker paradigm (JP Goux et al. An enabling framework for master-worker applications on the computational grid. In Proceedings of the Ninth IEEE International Symposium on High Performance Distributed Computing, pages 43-50, 2000).

The Shared Distributed Memory (30) must act in the following two roles:
1. As a repository for the objects describing the offered resources of each of the terminals (2) operating as service providers within the Mobile Grid (1).
2. As a distributed space for loosely coupled processes in order to synchronize their activities by exchanging the executable code.

Information related to the worker capabilities (the terminal (2) resources) will be published in the Shared Distributed Memory (30). Once an object describing the terminal resources is published into the shared distributed memory (30), it must be constantly updated (PUSH-like approach) by the terminal (2) offering their resources based on the actual terminal (2) capabilities which may vary over time.

Alternatively (PULL-like approach), these internal fields relating to the terminal resources may be updated internally in the terminal (2), in order to build internal statistics on the average resource load, average time the terminal (2) is able to connect with the shared distributed memory (30) etc. and when queried by the Monitoring system (10), publish the related resource information into the shared distributed memory (30).

Some of the resources provided by terminals (2) may not change during the worker life (for example: monitor size, CPU, ROM). Other resources provided by the terminals (2) will inevitably change. These include the CPU utilization, storage space, RAM utilization, network interface utilization, available bandwidth, battery level consumption, the average time the worker is connected with the shared distributed memory (30) (average connectivity time) for example. Any resource that can potentially be shared by the terminals is a resource that can be provided to the mobile grid.

Whenever a terminal (2) acting as a Master submits a task to the mobile grid to be published in the shared distributed memory (30), it contacts the Adaptive Reconfigurable Resource Broker (40) sending a description of the task (the task descriptor (60)) in terms of which resources are required from the workers To execute the task.

This method does not require any specific resource description language but the master must be able to specify the description of the resources required by the different tasks with different levels of semantics. An example of a task description is given later.

The adaptive reconfigurable resource broker (40) is in charge of submitting each submitted task to the shared distributed memory (30) to the best resource available according to the information gathered from the Monitoring System (10) and the Task Descriptor based on Equation 1 and 3 below.

The Monitoring System (10) is in charge of inspecting the resources published by the workers in the shared distributed memory (30) on an on-demand basis when asked by the Adaptive Reconfigurable Resource Broker (40).

These processes are illustrated in FIG. 2 which shows the interaction between a terminal (2) acting as a master, the adaptive reconfigurable resource broker (40), the monitoring system (10) and the shared distributed memory (30). Every time the master submits a task to be processed, the terminal (2) of the master contacts the adaptive reconfigurable resource broker (40). The specific task requirements are specified in the task descriptor (60). The adaptive reconfigurable resource broker (40) interacts with the monitoring system (10), which deals with gathering information from the shared distributed memory (30) on the resources provided by the terminals. The resource information has previously been published in the shared distributed memory (30). Based on the resource information gathered by the monitoring system (10) the adaptive reconfigurable resource broker (40) determines which terminal or terminals the tasks will be allocated to processing.

Finally, the Admission Control module (20) is in charge of interacting with the adaptive reconfigurable resource Broker (40) whenever a certain task needs to be split into different subtasks in order to benefit from the parallelization of the subtasks. In this case based on the information gathered by the Monitoring System (10), the Admission Control module (20) will decide the most appropriate strategy on how to split the original tasks into different subtasks and submit the different sub-tasks to the available workers based on the Broker selection policies.

FIG. 3 illustrates the processes occurring in the mobile grid when a master submits a task for processing to the mobile grid, and the task is divided into sub-tasks.

This figure shows the interaction between a terminal (2) acting as a master, the admission control module (30), the monitoring system (10), the shared distributed memory (30) and the adaptive reconfigurable resource broker (40). The terminal (2) interacts with the admission control module (20) and provides the module (10) with the task description (60). The monitoring service (10) gathers information from the shared distributed memory (30). The admission control module (20) uses the information gathered by the monitoring means to generate sub-tasks which can be executed by different terminals (2) in parallel. Each particular sub-task will have a different sub-task description (70). These sub-task descriptions (70) will be provided by the adaptive reconfigurable resource broker (40) to the best terminal (2) available for the sub-task.

When the adaptive reconfigurable resource broker (40) receives resource related information from the Monitoring System (10), it builds the Resource Binding matrix H_{N×M}, whose elements are:
hᵢⱼ(t)=αᵢC_{ON}_{ᵢ}(t)W_{if}R_{NORMij}C_{AVAILABLEij}(t)
i={1, . . . , N}
j={1, . . . , M}
   Equation 1: Resource Binding Matrix
   Where:
N: is the number of Workers available in the JavaSpace;
M: is the number of resources (CPU, MEMORY, etc.) considered;

$${α}_{i} * {C}_{{ON}_{i}} ( t ) = Connectivity Factor$$

$${C}_{{AVAILABLE}_{ij}} ( t ) {W}_{ij} {R}_{{NORM}_{ij}} = Resource Factor$$

$${C}_{{AVAILABLE}_{ij}} ( t ) = \{ \begin{matrix}{C}_{{UNLOADED}_{ij}} ( t ) - {T}_{ij} & if & {C}_{{UNLOADED}_{ij}} ( t ) - {T}_{ij} > {0}_{∀ j} \\ 0 & otherwise & \end{matrix}$$
R_{NORM N×M} (Normalized Resource Matrix): each element R_{NORM ij} of this N×M matrix is equal to Rᵢⱼ/NORMᵢ.
R_{N×M} (Resource Descriptor Matrix): each element Rᵢⱼ of the matrix is the particular device resource j considered (CPU cycle/sec, Memory bytes, Battery unit etc.) for the worker with ID i.
NORM_{M} (Resource Normalization Vector): each element of this matrix is used to normalize the elements of the resource Descriptor matrix according to the following rule:
   NORMⱼ=max(Rᵢⱼ)1<∀i<N
   Equation 2: Resource Normalization Matrix

Each unit element of this resource normalisation matrix is expressed as the inverse of the related resource unit so that the elements of the Normalized Resource Matrix are a-dimensional.

C_{ON N} (t) (Connectivity Factor Vector): these matrix elements are a-dimensional values which are proportional to the overall time a worker 1<i<N is connected to the shared distributed memory (30) and hence is available for executing tasks submitted to the shared distributed memory (30). This sector is proportional To the time the worker is effectively connected to the shared distributed memory (30) and able to interact with it.

C_{UNLOADED N} (t) (Resource Metadata Matrix): these matrix elements are similar to the Connectivity Factor matrix a-dimensional values considering the effective utilization of each resource. Hence the value (C_{UNLOADED ij} (t)*Rᵢⱼ) represents the effective utilization of resource j (e.g. j=1 memory load, j=2 storage space available, j=3 battery utilization, j=4 bandwidth available etc.) by worker with ID i.

W_{N×M} (t) (Resource Weight Matrix): each element of this matrix is a parameter associated with each resource (CPU, Memory etc.) and is configurable by the Adaptive Reconfigurable Resource Broker (40) according to the task descriptor.

α_{M} (Connectivity Factor Weight/Vector): the elements of this matrix are a-dimensional configurable values, and weight the Connectivity Factor in the equation, the matrix is configurable by the adoptive reconfigurable resource broker according to the task descriptor.

T_{N×M} (Resource Threshold Matrix): the elements of this matrix are user-defined parameters defining the users preferences when they do not want their terminal to provide resources to the mobile grid. For this purpose, the user can set a particular threshold for each resource of the terminal so that when the resource utilization crosses this utilization threshold the terminal will automatically leave the shared distributed memory (30). The value (C_{UNLOADED i}(t)−Tᵢⱼ) represents the exact amount of the particular resource i that the user is willing to provide to the other terminal in the Mobile Grid.

Based on the value of the Resource Binding matrix H elements, the adaptive reconfigurable resource broker chooses the worker with ID k, based on Equation 3:

$$Equation 3 \text{:} Heuristic {‖ h ‖}_{k} = max \sqrt{{\sum }_{j = 1}^{M} {h}_{ij}^{2}} Where i = \{ 1 , … , N \}$$

### EXAMPLE

In this section, we provide an example showing how a task received by the mobile grid (1) is allocated to a particular terminal (2) for processing. We assume the adaptive reconfigurable resource broker (40) receives the following Task Description.
Task requirements:

$$α = \{ \begin{matrix}1 & if & {C}_{ON} > 0.9 \\ 0 & otherwise & /\end{matrix} \\ \begin{matrix}CPU :> = 20 * {10}^{6} cycles \text{/} sec ; & {weight}_{CPU} = 1 ; \\ Memory :> = 100 Mb ; & {weight}_{Memory} = 1 ; \\ Storage :> = 100 Mb ; & {weight}_{Memory} = 0.1 ; \\ Battery :> = 40 Mb ; & {weight}_{Battery} = 0.1 ;\end{matrix}$$

Now we assume that five different terminals (2) are populating the Mobile Grid (1), publishing the following information into the Shared Distributed Memory (20).

TABLE 1
Worker Resource Description

| Terminal | | | | | |
|---|---|---|---|---|---|
| ID | CPU | Memory | Storage | Battery | C_{ON} |
| 1 | R_{CPU} = 100*10⁶ | R_{RAM} = 100 Mb; | R_{STORAGE} = | R_{BATTERY} = | 0.9 |
| | cycles/sec; | C_{UNLOADED} = 0.4; | 100*10⁶ bytes; | 100 units; | |
| | C_{UNLOADED} = 0.4; | T_{CPU} = 0.5; | C_{UNLOADED} = 0.4; | C_{UNLOADED} = 0.4; | |
| | T_{CPU} = 0.5; | | T_{STORAGE} = 0.5 | T_{CPU} = 0.5 | |
| 2 | R_{CPU} = 100*10³ | R_{RAM} = 100 Mb; | R_{STORAGE} = | R_{BATTERY} = | 0.9 |
| | cycles/sec; | C_{UNLOADED} = 0.5; | 100*10⁶ bytes; | 100 units; | |
| | C_{UNLOADED} = 0.5; | T_{CPU} = 0.5; | C_{UNLOADED} = 0.5; | C_{UNLOADED} = 0.5; | |
| | T_{CPU} = 0.5; | | T_{STORAGE} = 0.5 | T_{CPU} = 0.5 | |
| 3 | R_{CPU} = 50*10⁶ | R_{RAM} = 100 Mb; | R_{STORAGE} = | R_{BATTERY} = | 1 |
| | cycles/sec; | C_{UNLOADED} = 0.7; | 10⁵ bytes; | 100 units; | |
| | C_{UNLOADED} = 0.7; | T_{CPU} = 0.5; | C_{UNLOADED} = 0.7; | C_{UNLOADED} = 0.7; | |
| | T_{CPU} = 0.5; | | T_{STORAGE} = 0.5 | T_{CPU} = 0.5 | |
| 4 | R_{CPU} = 100*10⁶ | R_{RAM} = 100 Mb; | R_{STORAGE} = | R_{BATTERY} = | 1 |
| | cycles/sec; | C_{UNLOADED} = 0.7; | 100*10³ bytes; | 100 units; | |
| | C_{UNLOADED} = 0.7; | T_{CPU} = 0.5; | C_{UNLOADED} = 0.7; | C_{UNLOADED} = 0.7; | |
| | T_{CPU} = 0.5; | | T_{STORAGE} = 0.5 | T_{CPU} = 0.5 | |
| 5 | R_{CPU} = 100*10⁶ | R_{RAM} = 100 Mb; | R_{STORAGE} = | R_{BATTERY} = | 1 |
| | cycles/sec; | C_{UNLOADED} = 0.4; | 100*10³ bytes; | 100 units; | |
| | C_{UNLOADED} = 0.5; | T_{CPU} = 0.5; | C_{UNLOADED} = 0.9; | C_{UNLOADED} = 0.5; | |
| | T_{CPU} = 0.5; | | T_{STORAGE} = 0.5 | T_{CPU} = 0.5 | |

Based on the information gathered from the Monitoring System (10) (see Table 1) the adaptive reconfigurable resource broker (40) will build the following matrixes:
Resource Threshold Matrix:

$$T = [ \begin{matrix}0.5 & 0.5 & 0.5 & 0.5 \\ 0.5 & 0.5 & 0.5 & 0.5 \\ 0.5 & 0.5 & 0.5 & 0.5 \\ 0.5 & 0.5 & 0.5 & 0.5 \\ 0.5 & 0.5 & 0.5 & 0.5\end{matrix} ]$$

$$\begin{matrix}{C}_{UNLOADED} = [ \begin{matrix}0.4 & 0.4 & 0.4 & 0.4 \\ 0.5 & 0.5 & 0.5 & 0.5 \\ 0.7 & 0.7 & 0.7 & 07 \\ 0.7 & 0.7 & 0.7 & 0.7 \\ 0.9 & 0.9 & 0.9 & 0.9\end{matrix} ] \\ {C}_{UNLOADED} - T = [ \begin{matrix}- 0.1 & - 0.1 & - 0.1 & - 0.1 \\ 0 & 0 & 0 & 0 \\ 0.2 & 0.2 & 0.2 & 0 \\ 0.2 & 0.2 & 0.2 & 0.2 \\ 0.4 & 0.4 & 0.4 & 0.4\end{matrix} ] \\ {C}_{available} = [ \begin{matrix}0 & 0 & 0 & 0 \\ 0 & 0 & 0 & 0 \\ 0 & 0 & 0 & 0 \\ 0.2 & 0.2 & 0.2 & 0.2 \\ 0.4 & 0.4 & 0.4 & 0.4\end{matrix} ]\end{matrix}$$

Connectivity Factor Vector:
C_{ON}=[0.9 0.9 1 1 1]

Based on Table 1, the adaptive reconfigurable resource broker (40) will build up the following matrixes:

Connectivity Factor Weight Vector:
α=[0 0 1 1 1]
Resource Descriptor Matrix:

$$R = [ \begin{matrix}{10}^{8} cycles \text{/} sec & {10}^{8} bytes & {10}^{8} bytes & {10}^{2} unit \\ {10}^{5} cycles \text{/} sec & {10}^{8} bytes & {10}^{8} bytes & {10}^{2} unit \\ 5 * {10}^{7} cycles \text{/} sec & {10}^{5} bytes & {10}^{5} bytes & {10}^{2} unit \\ {10}^{8} cycles \text{/} sec & {10}^{8} bytes & {10}^{5} bytes & {10}^{3} unit \\ {10}^{8} cycles \text{/} sec & {10}^{9} bytes & {10}^{5} bytes & {10}^{2} unit\end{matrix} ]$$

Resource Normalization Vector:
N=[10⁸ sec/cycles 10⁸ bytes⁻¹ 10⁸ bytes⁻¹ 10² unit⁻¹]
Normalized Resource Matrix:

$${R}_{NORM} = [ \begin{matrix}1 & {10}^{- 1} & 1 & {10}^{- 1} \\ {10}^{- 3} & {10}^{- 1} 1 & 1 & {10}^{- 1} \\ 0.5 & {10}^{- 4} & {10}^{- 3} & {10}^{- 1} \\ 1 & {10}^{- 1} 1 & {10}^{- 3} & 1 \\ 1 & 1 & {10}^{- 3} & {10}^{- 1}\end{matrix} ]$$

Resource Weight Matrix:

$$W = [ \begin{matrix}1 & 1 & 0.1 & 0.1 \\ 1 & 1 & 0.1 & 0.1 \\ 1 & 1 & 0.1 & 0.1 \\ 1 & 1 & 0.1 & 0.1 \\ 1 & 1 & 0.1 & 0.1\end{matrix} ]$$

Based on these matrixes the adaptive reconfigurable resource broker (40) is now able to build up the
Resource Binding Matrix:

$$H = [ \begin{matrix}0 & 0 & 0 & 0 \\ 0 & 0 & 0 & 0 \\ 0.5 & {10}^{- 4} & {10}^{- 4} & {10}^{- 2} \\ 1 & {10}^{- 1} & {10}^{- 4} & {10}^{- 1} \\ 1 & 1 & {10}^{- 4} & {10}^{- 2}\end{matrix} ]$$

Hence, based on Equation 3, the terminal (2) chosen to process the task will be terminal with id 3

This resource management method is generic and does not target any specific mobile application domain. It aims to providing mobile users with the collective resources of a community of mobile and fixed devices (the Mobile Grid) in order to:

Allow terminals (2) to execute resource-intensive tasks (computational, battery, memory, bandwidth, etc.) by off-loading them to dynamically formed Mobile Grids.

Allow Terminals (2) to execute tasks with strict constraints execution. This means that by deploying these tasks to the other terminals (2), forming the Mobile Grid community, they are able to execute the same task faster or with better support for QoS requirements

A large range of applications can benefit from this mobile Grid resource management method. Examples can be mobile-gaming applications, image processing 3-D rendering, computational intensive analysis of data and so on.

1. A resource management method for enabling the sharing of resources for the processing of tasks in a virtual organisation of terminals, said method comprising the steps of:
storing information on resources provided by each of said terminals in a shared distributed memory means;
monitoring and receiving said resource information from said shared distributed memory means in a monitoring means;
receiving at least part of said resource information from said monitoring means in an adaptive reconfigurable resource broker means;
receiving a task for processing from one of said terminals in an admission control means;
processing said at least part of said resource information in said adaptive reconfigurable resource broker means to determine which said at least one terminal said task will be allocated to for processing.

2. A resource management method according to claim 1, wherein said adaptive reconfigurable resource broker means processes said at least part of said resource information to calculate a resource binding matrix HMXN.

3. A resource management method according to claim 2 wherein said resource binding matrix HMXN has elements given by
hᵢⱼ(t=αᵢC_{ONi}(t)WᵢⱼR_{NORMij}C_{AVAILABLEij}(t)
i={1, . . . ,N}j={1, . . . ,M}
wherein N is the number of said terminals available to process said tasks, M is the number of resources available to process said task, αC_{ONi}(t) is a connectivity factor and Wᵢⱼ R_{NORMIJ}C_{AVAILABLEij}(t) is a resource factor.

4. A resource management method according to claim 3 wherein C_{AVAILABLEij}(t) in said resource factor is defined as
$${C}_{{AVAILABLE}_{ij}} ( t ) = \{ \begin{matrix}{C}_{{UNLOADED}_{ij}} ( t ) - {T}_{ij} & if & {C}_{{UNLOADED}_{ij}} ( t ) - {T}_{ij} > {0}_{∀ j} \\ 0 & otherwise & \end{matrix}$$
wherein C_{UNLOADED}(t) is a resource metadata matrix, and Tᵢⱼ is the ᵢⱼ^{th} element of a resource threshold matrix.

5. A resource management method according to claim 4 wherein said resource threshold matrix is a matrix which defines the threshold at which each resource j, of each terminal i, becomes available to the resource management method for the processing of said tasks.

6. A resource management method according to claim 4 wherein said resource metadata matrix, C_{UNLOIDEDi}(t) represents the effective utilization of each resource.

7. A resource management method according to claim 3 wherein R_{NORMij} in said resource factor is an element of a normalized resource factor given by
$${R}_{NORMij} = \frac{Rj}{{NORM}_{i}} where {R}_{NORMij} = MAX ( Rij ) \frac{< Vi , N}{l ∠ ∇ i ∠ N}$$

8. A resource management method according to claim 3, wherein Wᵢⱼ in said resource factor is the ij^{th} element of a resource weight matrix associated with said resource and is configured by said adaptive reconfigurable resource broker means according to said task to be processed.

9. A resource management method according to claim 3 wherein or in said connectivity factor is a connectivity factor weight vector, which weights said connectivity factor and is configured by said adaptive reconfigurable resource broker means according to said task to be processed.

10. A resource management method according to claim 3 wherein C_{ONi}(t) in said connectivity factor is a connectivity factor vector which is proportional to the time a terminal 1, is connected to said shared distributed memory means.

11. A resource management method according to claim 3 wherein said adaptive reconfigurable resource broker means allocates said task to a terminal k is according to the equation:
$${‖ h ‖}_{k} = max \sqrt{{\sum }_{j = 1}^{M} {h}_{ij}^{2}} where i = \{ 1 , … , N \}$$

12. A resource management method according to claim 1 farther including the step of splitting said task for processing received in said adaptive reconfigurable broken means into parallel sub-tasks and allocating said sub-tasks to different said terminals for processing via said admission control means.

13. A resource management method according to claim 1 wherein said shared distributed memory means said monitoring means, said adaptive reconfigurable resource broker means and said admission control means are all provided by one said terminal in said virtual organisation.

14. A resource management framework according to claim 1 wherein said shared distributed memory means, said monitoring means, said adaptive reconfigurable resource broker means and admission control means are all provided by more than one said terminal in said virtual organisation.

15. A resource management method according to claim 1 wherein said terminal is a digital device.

16. A resource management method according to claim 15 wherein said digital device is a personal computer, Personal Digital Assistant, mobile telephone or sensor.

17. A resource management method according to claim 16 wherein said resource is a resource that can be shared among the terminals.

18. A resource management method according to claim 17 wherein said resources include monitor size, CPU power and RAM.

19. (canceled)
